(19) United States
(12) Patent Application Publication
(10) Pub. No.: US 2012/0319610 A1
(43) Pub. Date: Dec. 20, 2012

(54) LED LIGHTING APPARATUS

(75) Inventor: Mitsutomo YOSHINAGA, Niiza-shi (JP)

(73) Assignee: Sanken Electric Co., Ltd., Niiza-shi (JP)

(21) Appl. No.: 13/523,044

(22) Filed: Jun. 14, 2012

(30) Foreign Application Priority Data
Jun. 16, 2011 (JP) 2011-133943
Dec. 5, 2011 (JP) 2011-265527

(51) Int. Cl. H05B 37/02

(52) U.S. Cl. 315/210

(57) ABSTRACT

An LED lighting apparatus includes a series circuit that includes a primary winding P of a transformer T and a switching element Q1, the primary winding being connected to a triac dimmer 3 for phase-controlling an AC input voltage, a control circuit 14 that carries out ON/OFF control of the switching element Q1, a secondary winding S of the transformer that supplies power to LEDs, a bleeder 23 that selectively passes a first current and a second current lower than the first current, and a bleeder controller 21 that is connected to the bleeder 23 and controls the bleeder 23 to pass the first current at least at the start of conduction of the triac dimmer 3.

### BACKGROUND OF THE INVENTION

1. Field of the Invention

The present invention relates to an LED lighting apparatus for driving a plurality of LEDs.

2. Description of Related Art

An LED lighting apparatus for driving a plurality of LEDs (light emitting diodes) is disclosed in, for example, Japanese Unexamined Patent Application Publication No. 2011-003326 (Patent Document 1).

The related art of Patent Document 1 relates to an insulated LED lighting apparatus with a triac dimmer and to an LED illuminating apparatus. To stably keep the triac dimmer in an ON state, the LED lighting apparatus passes a minimum load current as a holding current for the triac dimmer.

If the holding current decreases to an insufficient level, the triac dimmer will repeatedly turn on and off to develop troubles such as flickering and noise on LEDs. To avoid the troubles, the LED lighting apparatus with the triac dimmer needs a bleeder for passing the holding current.

### SUMMARY OF THE INVENTION

The holding current from the bleeder to the triac dimmer, however, is a loss to deteriorate the efficiency of the LED lighting apparatus.

An AC voltage from the triac dimmer has a phase-controlled intermittent waveform, and at a rise of the AC voltage, a current larger than the holding current is hardly supplied to the triac dimmer. In this case, the triac dimmer turns off and becomes unstable. To deal with this problem, the related art of Patent Document 1 arranges an input capacitor to always operate a control IC. This, however, increases the number of parts of the LED lighting apparatus.

The present invention provides an LED lighting apparatus capable of stably operating the triac dimmer and realizing high efficiency.

According to an aspect of the present invention, the LED lighting apparatus includes a series circuit that includes a primary winding of a transformer and a switching element, the primary winding being connected to a triac dimmer for phase-controlling an AC input voltage, a control circuit that carries out ON/OFF control of the switching element, a secondary winding of the transformer that supplies power to LEDs, a bleeder that selectively passes a first current or a second current lower than the first current, and a bleeder controller that is connected to the bleeder and controls the bleeder to pass the first current at least at the start of conduction of the triac dimmer.

### BRIEF DESCRIPTION OF THE DRAWINGS

FIG. 1 is a circuit diagram illustrating an LED lighting apparatus according to Embodiment 1 of the present invention;

FIG. 2 is a circuit diagram illustrating an LED lighting apparatus according to Embodiment 2 of the present invention;

FIGS. 3A, 3B, 4A, and 4B are operating waveforms of LED lighting apparatuses, in which FIGS. 3B and 4B are of the present invention and FIGS. 3A and 4A are of a related art;

FIG. 5 is a graph illustrating power efficiency of the LED lighting apparatuses of the present invention and related art;

FIG. 6 is a circuit diagram illustrating an LED lighting apparatus according to Embodiment 3 of the present invention;

FIG. 7 is a circuit diagram illustrating an LED lighting apparatus according to Embodiment 4 of the present invention;

FIG. 8 is a circuit diagram illustrating an LED lighting apparatus according to Embodiment 5 of the present invention;

FIG. 9 is a circuit diagram illustrating an LED lighting apparatus according to Embodiment 6 of the present invention; and

FIG. 10 is a circuit diagram illustrating an LED lighting apparatus according to Embodiment 7 of the present invention.

### DESCRIPTION OF THE PREFERRED EMBODIMENTS

LED lighting apparatuses according to embodiments of the present invention will be explained in detail with reference to the drawings.

### Embodiment 1

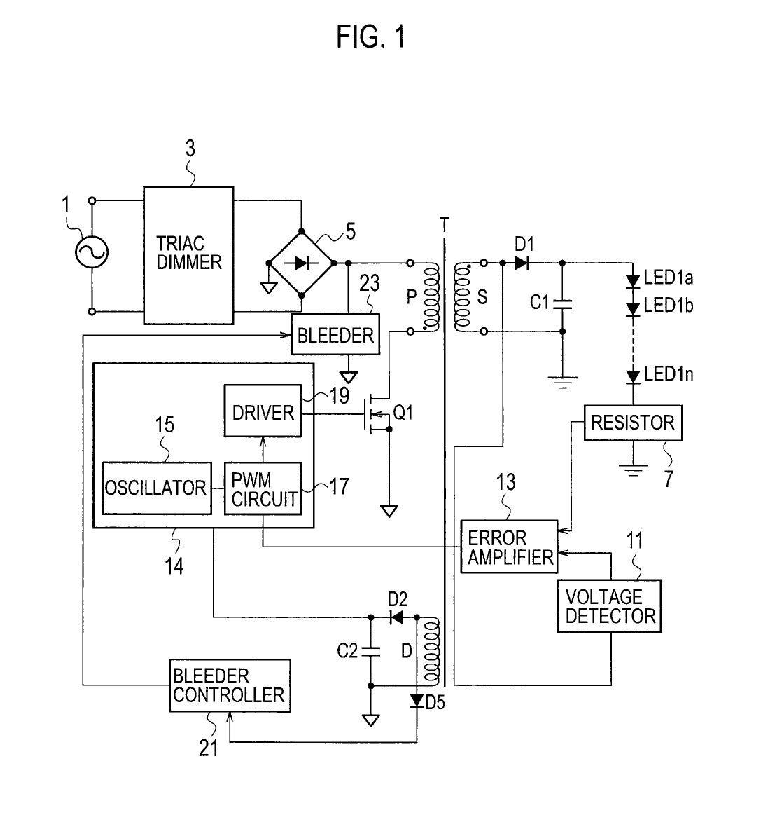

FIG. 1 is a circuit diagram illustrating an LED lighting apparatus according to Embodiment 1 of the present invention. This apparatus is an insulated LED lighting apparatus with a dimming function.

In FIG. 1, an AC power source 1 supplies an AC input voltage to a triac dimmer 3. The triac dimmer 3 phase-controls the AC input voltage. The phase-controlled AC input voltage is rectified through a full-wave rectifier 5.

Connected between an output end of the full-wave rectifier 5 and a primary ground is a series circuit including a primary winding P of a switching transformer T and a switching element Q1. The switching element Q1 is, for example, a MOSFET and is PWM-controlled by a control circuit 14. The control circuit 14 includes an oscillator 15, a PWM circuit 17, and a driver 19.

A secondary winding S of the switching transformer T is wound in opposite phase with respect to the primary winding P and supplies power to a load, i.e., LEDs LED1a to LED1n. Both ends of the secondary winding S are connected to a series circuit including a diode D1 and a capacitor C1. The diode D1 and capacitor C1 form a rectifying-smoothing circuit. Connected between a connection point of the diode D1 and capacitor C1 and a secondary ground is a series circuit including the series-connected LEDs LED1a to LED1n and a resistor 7.

The resistor 7 detects a current passing through the series-connected LEDs LED1a to LED1n and outputs a current detection signal to an error amplifier 13.

A voltage detector 11 provides the error amplifier 13 with a dimming signal that is formed by smoothing a high-frequency voltage proportional to a phase-controlled AC input voltage that is generated by the secondary winding S of the switching transformer T when the diode D1 is OFF.

The error amplifier 13 has a reference voltage whose level changes according to the dimming signal from the voltage detector 11. The error amplifier 13 amplifies an error between the reference voltage and the current detection signal from the resistor 7 and outputs an error amplified signal. The PWM circuit 17 compares the error amplified signal with a reference signal from the oscillator 15, and according to a result of the comparison, carries out PWM control to determine an ON/OFF duty factor of a pulse signal, i.e., a PWM signal. According to the PWM signal, the driver 19 turns on/off the switching element Q1.

The LED lighting apparatus also includes a bleeder 23, a bleeder controller 21, and an auxiliary winding D of the transformer T. The bleeder 23 passes a predetermined holding current of the triac dimmer 3. The auxiliary winding D is connected to a series circuit including a diode D2 and a capacitor C2. The auxiliary winding D generates a phase-controlled AC voltage, which is rectified and smoothed through the diode D2 and capacitor C2 into a DC voltage that is supplied to the control circuit 14 and bleeder controller 21. The bleeder 23 is connected to an output end of the full-wave rectifier 5.

The bleeder 23 is a variable impedance element configured to selectively pass a first current and a second current lower than the first current, the selected current being supplied as a bleeder current. The bleeder 23 is connected to the bleeder controller 21 that detects a voltage of the auxiliary winding D, and according to the detected voltage, controls the bleeder 23 to pass one of the first and second currents.

The bleeder controller 21 controls the bleeder 23 such that the bleeder 23 may pass the first current larger than the second current at least when the triac dimmer 3 is turned on.

Operation of the LED lighting apparatus according to Embodiment 1 will be explained. First, the AC power source 1 is activated to apply an AC voltage through the triac dimmer 3 to the primary winding P of the transformer T. A starter (not illustrated) charges the capacitor C2. When the capacitor C2 is charged, the switching element Q1 starts to be turned on and off to generate AC voltages on the secondary winding S and auxiliary winding D of the transformer T. The AC voltage of the auxiliary winding D is applied to a diode D5 so that a DC voltage is applied to the bleeder controller 21. This DC voltage has a voltage value corresponding to a voltage value of the AC voltage of the auxiliary winding D.

If the DC voltage is lower than a threshold voltage, i.e., if it is the start of conduction of the triac dimmer 3, the bleeder controller 21 controls the bleeder 23 to pass the first current as the bleeder current. Once the operation of the triac dimmer 3 is stabilized, the bleeder controller 21 controls the bleeder 23 to pass the second current that is lower than the first current.

In this way, the LED lighting apparatus of Embodiment 1 employs the bleeder controller 21 that controls the bleeder 23 to pass the first current as a holding current to the triac dimmer 3 when the triac dimmer 3 is turned on. After the operation of the triac dimmer 3 is stabilized, the bleeder controller 21 controls the bleeder 23 to pass the second current that is lower than the first current. Namely, the LED lighting apparatus of Embodiment 1 operates the bleeder 23 only for a required minimum period, to improve the efficiency of the LED lighting apparatus. Unlike the related art of Patent Document 1, the LED lighting apparatus of Embodiment 1 needs no input capacitor, and therefore, is simple.

### Embodiment 2

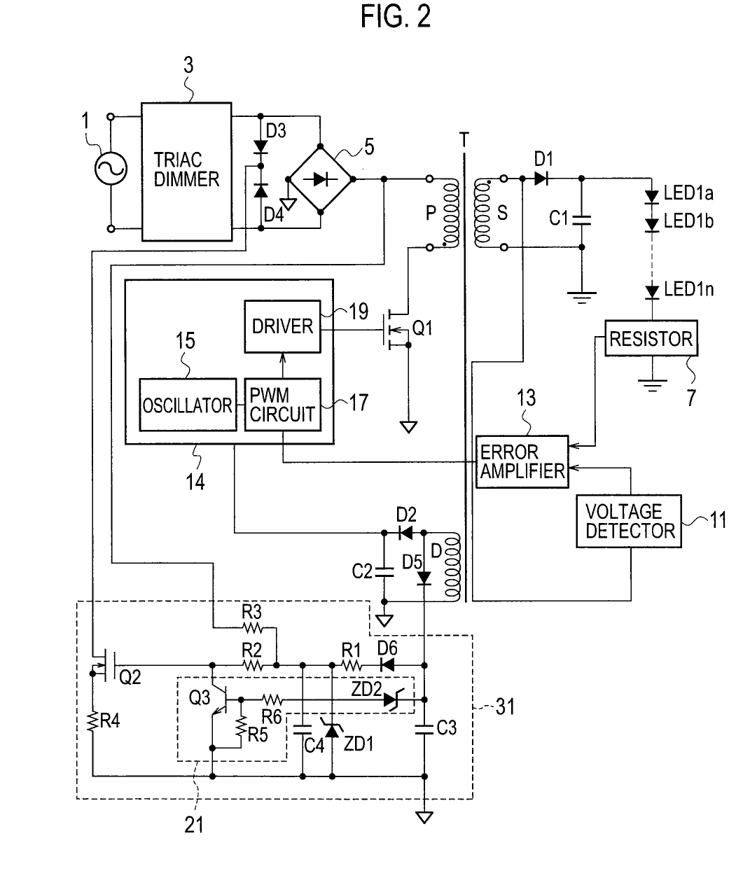

FIG. 2 is a circuit diagram illustrating an LED lighting apparatus according to Embodiment 2 of the present invention. Instead of the bleeder 23 of Embodiment 1, Embodiment 2 employs a bleeder 31 incorporating a bleeder controller 21. In addition, Embodiment 2 connects a series circuit including diodes D3 and D4 to output ends of a triac dimmer 3. The bleeder 31 is connected through cathodes of the diodes D3 and D4 to input ends of a full-wave rectifier 5.

In the bleeder 31, a connection point between an auxiliary winding D and a diode D2 is connected through a diode D5 to an anode of a diode D6, a first end of a capacitor C3, and a cathode of a Zener diode ZD2. A cathode of the diode D6 is connected through a resistor R1 to a first end of a resistor R3, a first end of a resistor R2, a cathode of a Zener diode ZD1, and a first end of a capacitor C4.

A second end of the resistor R3 is connected to an output end of the full-wave rectifier 5. A second end of the resistor R2 is connected to a collector of an npn-type transistor Q3 and a gate of an n-type MOSFET Q2. Abase of the transistor Q3 is connected through a resistor R6 to an anode of the Zener diode ZD2. The base of the transistor Q3 is connected through a resistor R5 to an emitter of the transistor Q3.

A drain of the MOSFET Q2 is connected to the connection point of the diodes D3 and D4 and a source of the MOSFET Q2 is connected to a first end of a resistor R4. A second end of the resistor R4, the emitter of the transistor Q3, a second end of the capacitor C4, an anode of the Zener diode ZD1, and a second end of the capacitor C3 are commonly connected.

The transistor Q3, resistors R5 and R6, and Zener diode ZD2 form the bleeder controller 21.

Operation of the LED lighting apparatus according to Embodiment 2 will be explained. A voltage at the first end of the capacitor C3 is defined as Vc.

First, the auxiliary winding D generates an AC voltage. When the voltage Vc of the capacitor C3 exceeds a threshold voltage Vth due to heavy load, the Zener diode ZD2 breaks down to pass a current to the base of the transistor Q3. This results in turning on the transistor Q3 and off the MOSFET Q2, and therefore, the bleeder 31 causes no operation and passes a bleeder current of nearly zero, i.e., the second current.

Under light load, or at a rise of an AC voltage under heavy load, the voltage Vc of the capacitor C3 is low to turn off the Zener diode ZD2 and transistor Q3. As a result, the voltage Vc is applied through the diode D6 and resistors R1 and R2 to the gate of the MOSFET Q2, to turn on the MOSFET Q2. At this time, the bleeder 31 operates to pass the first current as a bleeder current.

According to Embodiment 2, the bleeder controller 21 determines a load state from the voltage generated by the auxiliary winding D. If load is light, the bleeder controller 21 controls the bleeder 31 to pass the first current. If load is heavy and if the voltage generated by the auxiliary winding D is at a rise, the bleeder controller 21 also controls the bleeder 31 to pass the first current. Accordingly, Embodiment 2 provides effects similar to those of Embodiment 1.

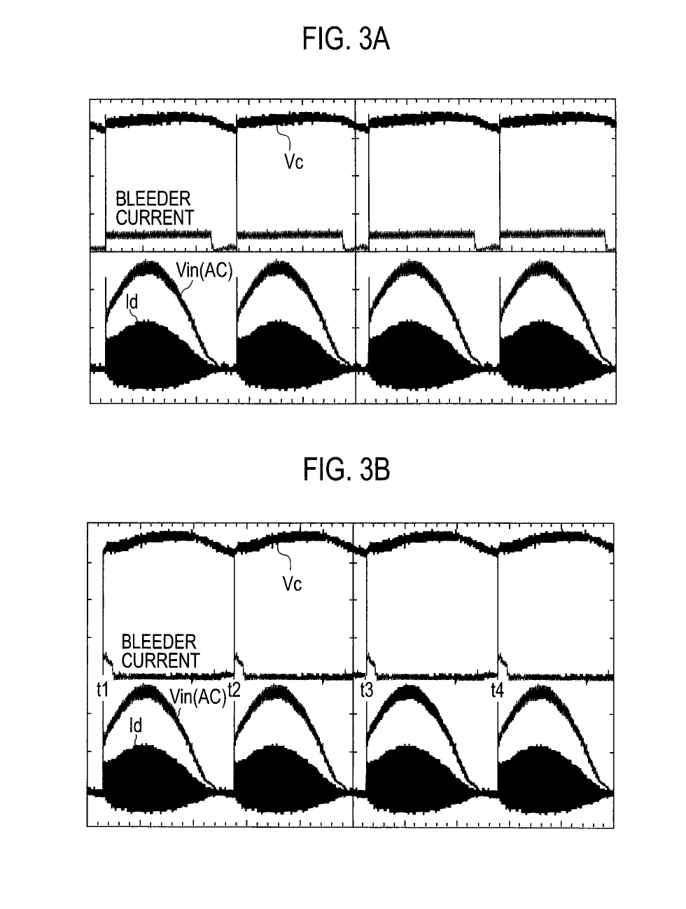

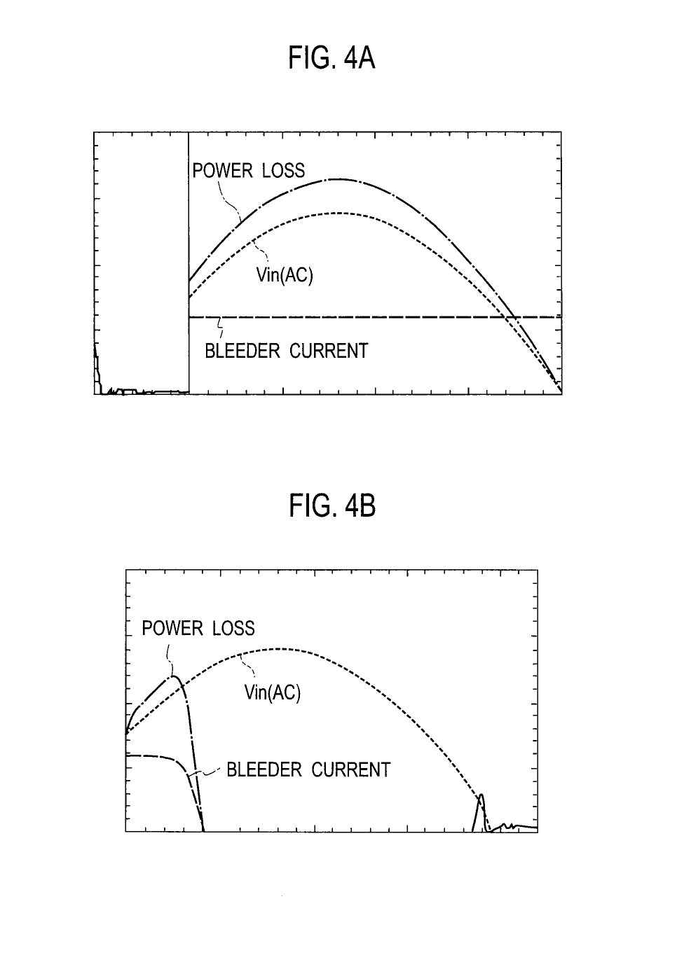

FIG. 3B is a graph illustrating the voltage Vc of the capacitor C2, a bleeder current, an AC voltage Vin (AC), and a drain current Id of the switching element Q1 according to the present invention employing the bleeder controller 21. The AC voltage Vin(AC) is a voltage generated at a connection point between the full-wave rectifier 5 and the transformer T. The triac dimmer 3 becomes conductive at each of time points t1, t2, t3, and t4. In FIG. 3B, the first current larger than the second current is passed as the bleeder current at a rise of the AC voltage of the auxiliary winding D. FIG. 4B is a graph illustrating the bleeder current, AC voltage Vin (AC), and a power loss caused by the bleeder current according to the present invention.

FIG. 3A is a graph illustrating the voltage Vc of the capacitor C2, a bleeder current, an AC voltage Vin (AC), and a drain current Id of the switching element Q1 according to a related art having no bleeder controller 21. FIG. 4A is a graph illustrating the bleeder current, AC voltage Vin(AC), and a power loss caused by the bleeder current according to the related art having no bleeder controller 21.

The related art of FIGS. 3A and 4A having no bleeder controller 21 causes a large power loss because it always passes the bleeder current from a bleeder.

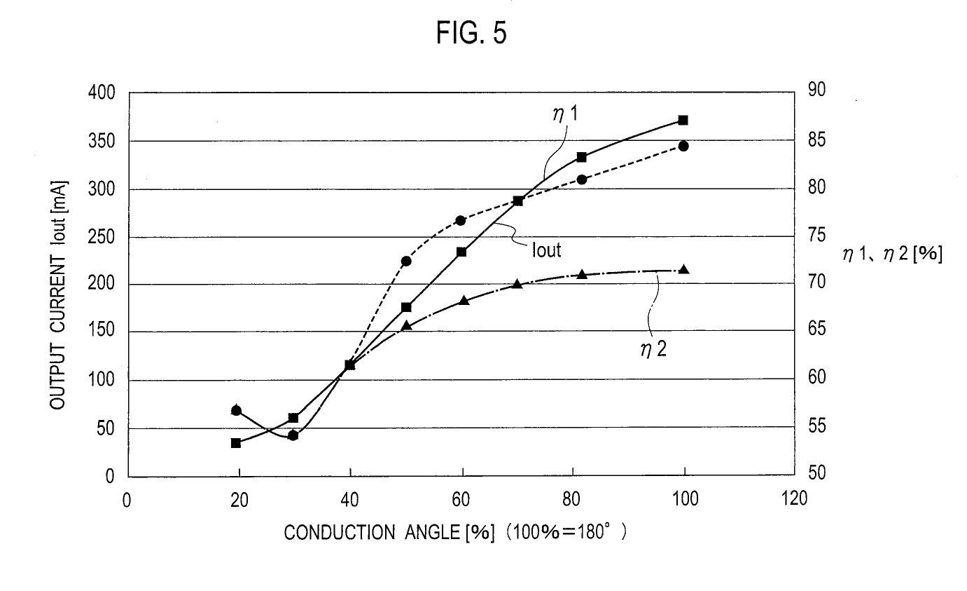

FIG. 5 is a graph illustrating power efficiency of the LED lighting apparatuses of the present invention and related art. In FIG. 5, lout is an output current (load current), η1 is the efficiency of the present invention having the bleeder controller 21, and η2 is the efficiency of the related art having no bleeder controller 21. It is apparent in FIG. 5 that the present invention demonstrates better efficiency than the related art. When a conduction angle is small, i.e., when load is light, the bleeder 31 (FIG. 2) always passes a current, and therefore, the present invention and related art demonstrate the same efficiency.

### Embodiment 3

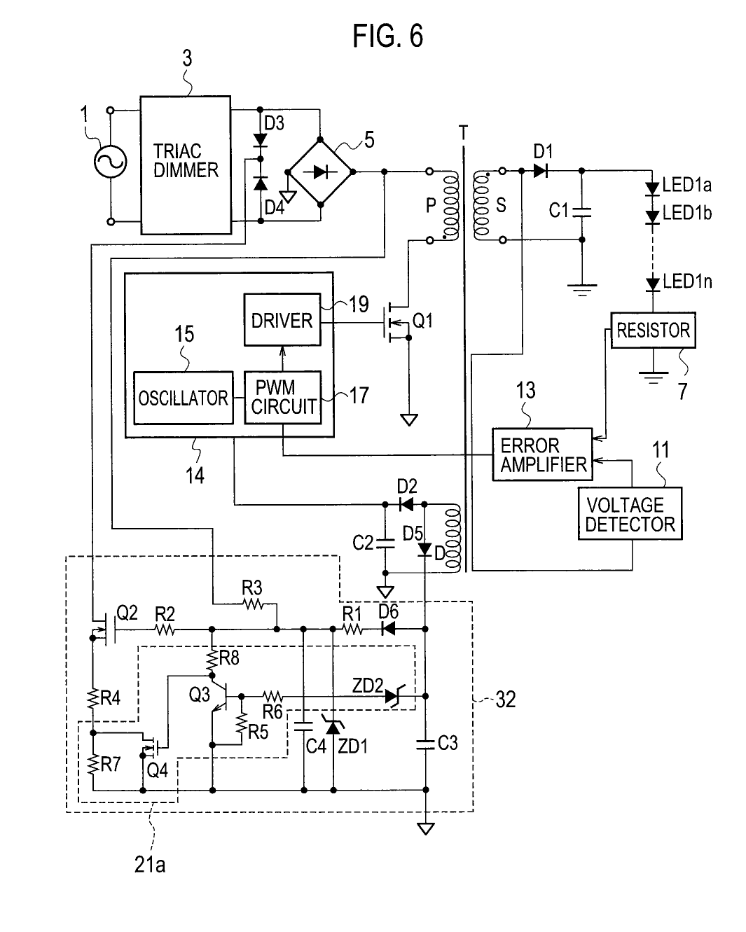

FIG. 6 is a circuit diagram illustrating an LED lighting apparatus according to Embodiment 3 of the present invention. Compared with the bleeder 31 of Embodiment 2 illustrated in FIG. 2, a bleeder 32 of Embodiment 3 illustrated in FIG. 6 additionally has resistors R8 and R7 and a MOSFET Q4.

A first end of the resistor R8 is connected to a collector of a transistor Q3 and a second end of the resistor R8 is connected to resistors R2 and R3. A second end of a resistor R4 is connected to a first end of the resistor R7 and a second end of the resistor R7 is connected to a second end of a capacitor C3.

A gate of the MOSFET Q4 is connected to the collector of the transistor Q3, a drain of the MOSFET Q4 is connected to a connection point of the resistors R4 and R7, and a source of the MOSFET Q4 is connected to the second end of the capacitor C3.

Operation of the LED lighting apparatus according to Embodiment 3 will be explained.

An AC power source 1 supplies an AC voltage and a switching element Q1 starts to turn on and off. When a voltage Vc of the capacitor C3 exceeds a threshold voltage Vth due to heavy load, a Zener diode ZD2 breaks down to supply a current to the base of the transistor Q3 and turn on the transistor Q3. This results in turning off the MOSFET Q4 and passing a bleeder current to the series circuit of the resistors R4 and R7. The bleeder current, therefore, decreases to a second current.

Under light load, or under heavy load with a triac dimmer 3 starting to be conductive, the voltage Vc of the capacitor C3 is low to turn off the Zener diode ZD2 and transistor Q3. As a result, the voltage Vc is applied through a diode D6 and the resistor R8 to the gate of the MOSFET Q4, to turn on the MOSFET Q4. At this time, a MOSFET Q2 is also turned on. Then, the bleeder current passes only through the resistor R4 and increases to a first current that is higher than the second current.

In this way, Embodiment 3 provides effects similar to those of Embodiment 1.

### Embodiment 4

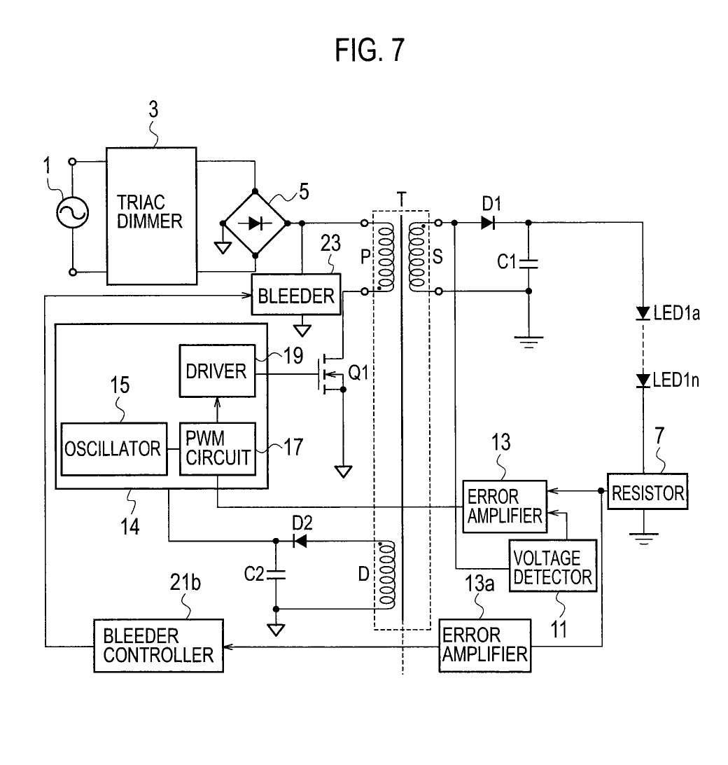

FIG. 7 is a circuit diagram illustrating an LED lighting apparatus according to Embodiment 4 of the present invention. Unlike Embodiment 1 of FIG. 1 that supplies the voltage of the auxiliary winding D to the bleeder controller 21, Embodiment 4 of FIG. 7 employs an error amplifier 13a that supplies an error voltage to a bleeder controller 21b.

The error amplifier 13a amplifies an error voltage between a voltage generated by an LED current passing through a resistor 7 and a reference voltage and outputs the amplified error voltage through an insulated signal transmission element such as a photocoupler (not illustrated) to the bleeder controller 21b. According to the amplified error voltage, the bleeder controller 21b controls a bleeder 23 to select a bleeder current.

For example, the bleeder controller 21b controls the bleeder 23 to pass a first current if the amplified error voltage from the error amplifier 13a is equal to or higher than a predetermined value and a second current (it may be nearly zero) lower than the first current if the amplified error voltage is lower than the predetermined value. The bleeder controller 21b may control the bleeder 23 to pass the first current if the amplified error voltage is equal to or higher than the predetermined value and the second current after a predetermined time elapses.

In this way, the bleeder controller 21b of Embodiment 4 controls the bleeder 23 to pass the first current as a holding current at a rise of an AC voltage at which the amplified error voltage from the error amplifier 13a is equal to or higher than the predetermined value. Once the operation of the LED lighting apparatus is stabilized, the amplified error voltage becomes lower than the predetermined value, and therefore, the bleeder controller 21b controls the bleeder 23 to pass the second current that is lower than the first current.

Embodiment 4 provides effects similar to those of Embodiment 1.

### Embodiment 5

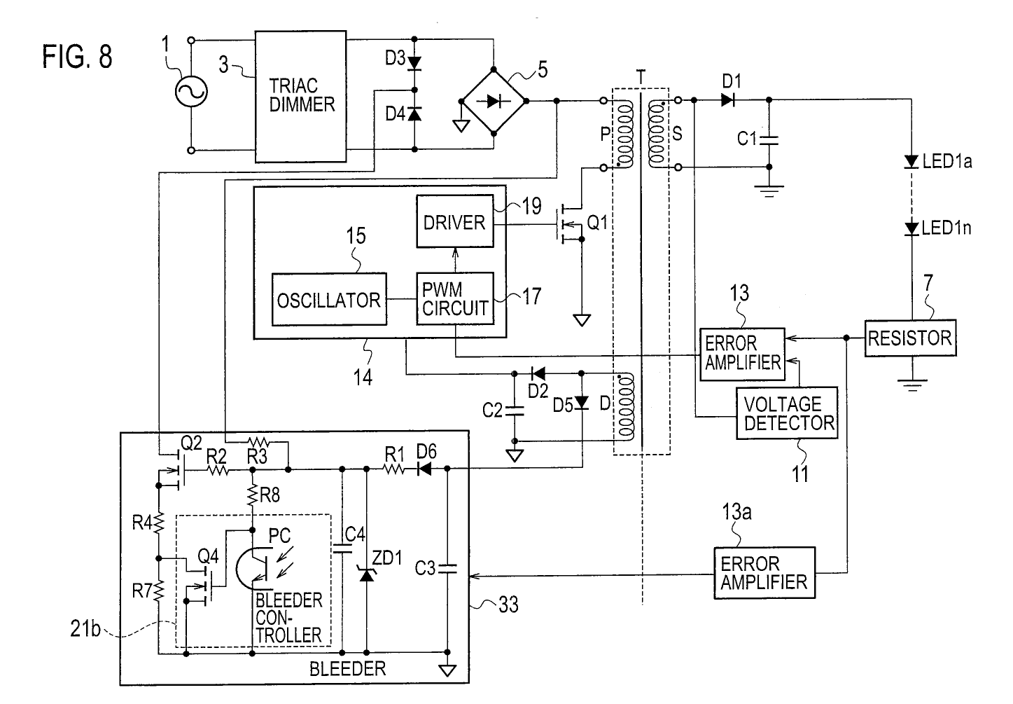

FIG. 8 is a circuit diagram illustrating an LED lighting apparatus according to Embodiment 5 of the present invention. Instead of the bleeder 23 of Embodiment 4 illustrated in FIG. 7, Embodiment 5 of FIG. 8 employs a bleeder 33 incorporating a bleeder controller 21b. In addition, Embodiment 4 connects a series circuit including diodes D3 and D4 to output ends of a triac dimmer 3. The bleeder 33 is connected through cathodes of the diodes D3 and D4 to input ends of a full-wave rectifier 5.

In the bleeder 33, a connection point between an auxiliary winding D and a diode D2 is connected through a diode D5 to an anode of a diode D6 and a first end of a capacitor C3. A cathode of the diode D6 is connected through a resistor R1 to a first end of a resistor R3, a first end of a resistor R2, a cathode of a Zener diode ZD1, and a first end of a capacitor C4.

A second end of the resistor R3 is connected to an output end of the full-wave rectifier 5. A second end of the resistor R2 is connected to a gate of an n-type MOSFET Q2. A second end of the resistor R8 is connected to a collector of a photocoupler PC and a gate of a MOSFET Q4.

A drain of the MOSFET Q2 is connected to a connection point of the diodes D3 and D4 and a source of the MOSFET Q2 is connected to a series circuit of resistors R4 and R7. A connection point of the resistors R4 and R7 is connected to a drain of the MOSFET Q4. A first end of the resistor R7, a source of the MOSFET Q4, and an emitter of the photocoupler PC are commonly connected.

The photocoupler PC and MOSFET Q4 form the bleeder controller 21b.

Operation of the LED lighting apparatus according to Embodiment 5 will be explained.

If load is heavy, a large current is passed to LEDs LED1a to LED1n, and therefore, the photocoupler PC passes a large current. This results in turning off the MOSFET Q4 and passing a bleeder current through the series circuit of the resistors R4 and R7, thereby decreasing the bleeder current to a second current.

If load is light, or if load is heavy with a triac dimmer 3 starting to be conductive, a small current is passed through the LEDs LED1a to LED1n, and therefore, the photocoupler PC passes a small current. This results in turning on the MOSFET Q4 and passing the bleeder current only through the resistor R4, thereby increasing the bleeder current to a first current that is higher than the second current.

In this way, Embodiment 5 provides effects similar to those of Embodiment 1.

### Embodiment 6

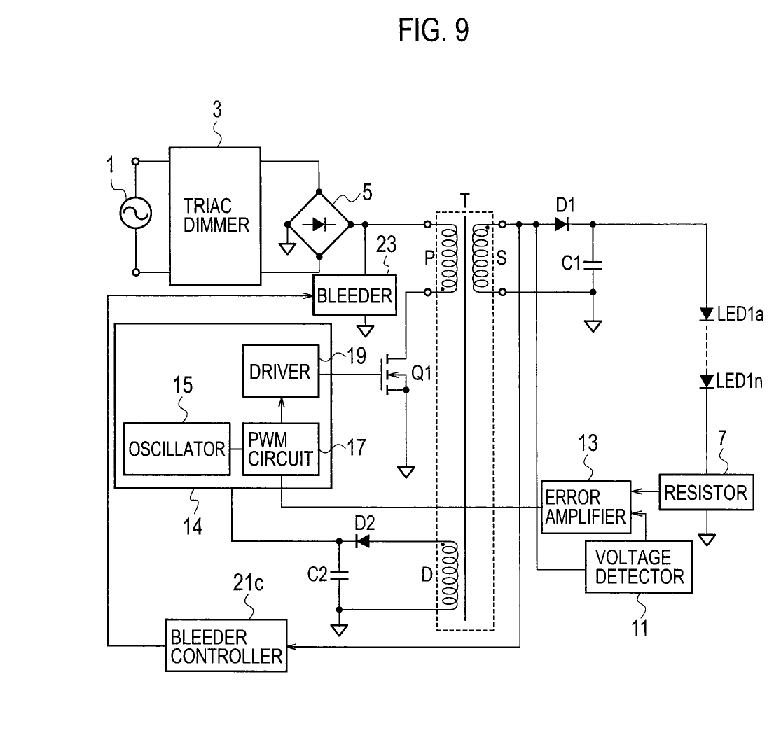

FIG. 9 is a circuit diagram illustrating an LED lighting apparatus according to Embodiment 6 of the present invention. According to Embodiment 6, a primary ground and a secondary ground are commonly connected. Unlike Embodiment 1 illustrated in FIG. 1 that supplies the voltage of the auxiliary winding D to the bleeder controller 21, Embodiment 6 illustrated in FIG. 9 employs a bleeder controller 21c that switches bleeder currents from one to another according to the value of a voltage generated by a secondary winding S of a transformer T.

For example, the bleeder controller 21c controls a bleeder 23 to pass a first current if the voltage value of the secondary winding S is lower than a predetermined value and a second current (it may be nearly zero) lower than the first current if the voltage value of the secondary winding S is equal to or higher than the predetermined value. Instead, the bleeder controller 21c may control the bleeder 23 to pass the first current if the voltage value of the secondary winding S is lower than the predetermined value and the second current when a predetermined time elapses thereafter.

In this way, the bleeder controller 21c according to Embodiment 6 controls the bleeder 23 to cause the first current as a holding current at a rise of an AC voltage at which the voltage value of the secondary winding S is lower than the predetermined value. Once the operation of the LED lighting apparatus is stabilized, the voltage value of the secondary winding S becomes equal to or higher than the predetermined value, and therefore, the bleeder controller 21c controls the bleeder 23 to cause the second current lower than the first current.

Embodiment 6 provides effects similar to those of Embodiment 1. In addition, Embodiment 6 needs no insulated signal transmission element such as a photocoupler, and therefore, the LED lighting apparatus according to Embodiment 6 is simple.

### Embodiment 7

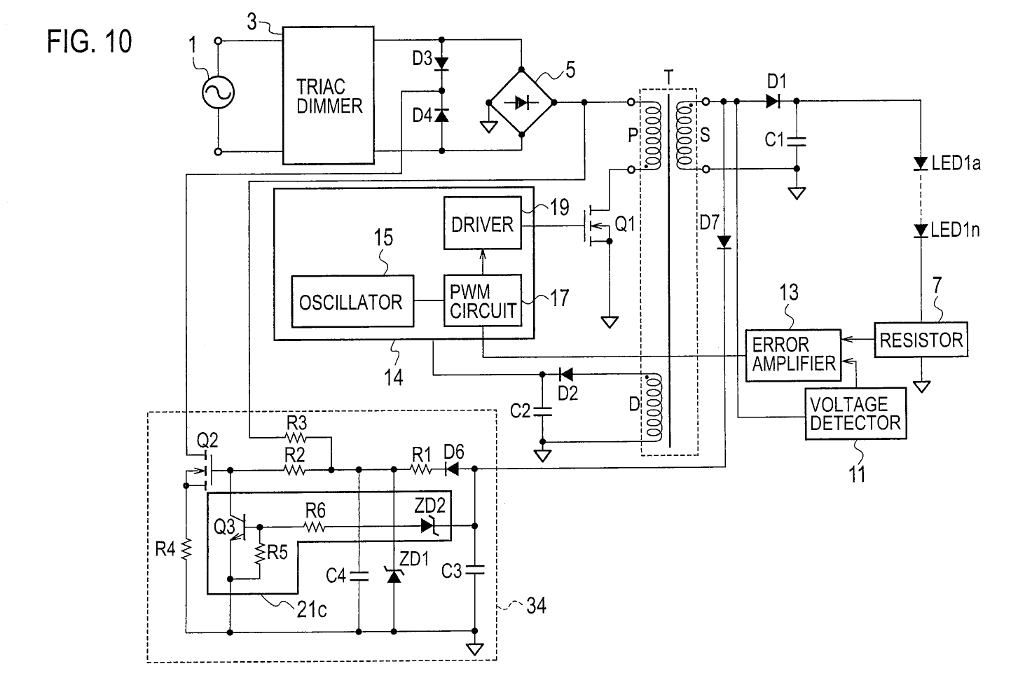

FIG. 10 is a circuit diagram illustrating an LED lighting apparatus according to Embodiment 7 of the present invention. Instead of the bleeder 23 of Embodiment 1 illustrated in FIG. 1, Embodiment 7 of FIG. 10 employs a bleeder 34 incorporating a bleeder controller 21c.

In the bleeder 34, an anode of a diode D6 is connected through a diode D7 to a first end of a secondary winding S of a transformer T. The anode of the diode D6, a first end of a capacitor C3, and a cathode of a Zener diode ZD2 are commonly connected. A cathode of the diode D6 is connected through a resistor R1 to a first end of a resistor R3, a first end of a resistor R2, a cathode of a Zener diode ZD1, and a first end of a capacitor C4.

A second end of the resistor R3 is connected to an output end of a full-wave rectifier 5. A second end of the resistor R2 is connected to a collector of an n-type transistor Q3 and a gate of an n-type MOSFET Q2. A base of the transistor Q3 is connected through a resistor R6 to an anode of the Zener diode ZD2. The base and emitter of the transistor Q3 are connected to each other through a resistor R5.

A drain of the MOSFET Q2 is connected to a connection point of diodes D3 and D4 and a source of the MOSFET Q2 is connected to a first end of a resistor R4. A second end of the resistor R4, an emitter of the transistor Q3, a second end of the capacitor C4, an anode of the Zener diode ZD1, and a second end of the capacitor C3 are commonly connected.

The transistor Q3, resistors R5 and R6, and Zener diode ZD2 form the bleeder controller 21c.

Operation of the LED lighting apparatus according to Embodiment 7 will be explained.

First, an AC power source 1 supplies an AC voltage and a switching element Q1 starts to turn on and off. At this time, load becomes heavy. The secondary winding S generates a voltage to break down the Zener diode ZD2. This results in passing a current through the base of the transistor Q3 to turn on the transistor Q3. Then, no bleeder current passes. Namely, a second current (substantially zero) causes as a bleeder current.

Under light load, or under heavy load with a triac dimmer 3 starting to be conductive, the voltage of the secondary winding S is low to turn off the Zener diode ZD2 and transistor Q3. As a result, the voltage of the secondary winding S is applied through the diodes D7 and D6 and resistors R1 and R2 to the gate of the MOSFET Q2. Then, the MOSFET Q2 turns on to pass a bleeder current through the resistor R4. This bleeder current is a first current that is higher than the second current.

Embodiment 7 provides effects similar to those of Embodiments 1 and 6.

The present invention is not limited to the LED lighting apparatuses of Embodiments 1 to 7. Although the LED lighting apparatuses of Embodiments 1 to 7 are of a flyback system, the present invention is also applicable to LED lighting apparatuses of a forward-converter-type power supply system.

As mentioned above, the LED lighting apparatus according to the present invention employs the bleeder controller that controls a bleeder to pass a first current as a holding current at least at the start of conduction of a triac dimmer, and after the operation of the triac dimmer is stabilized, a second current lower than the first current. With this configuration, the LED lighting apparatus of the present invention is simple, highly efficient, and capable of stably operating the triac dimmer.

The present invention is applicable to LED lighting apparatuses for lighting LEDs and LED illuminating apparatuses.

This application claims benefit of priority under 35USC §119 to Japanese Patent Applications No. 2011-133943, filed on Jun. 16, 2011 and No. 2011-265527, filed on Dec. 5, 2011, the entire contents of which are incorporated by reference herein.

What is claimed is:

1. An LED lighting apparatus comprising:
a series circuit including a primary winding of a transformer and a switching element, the primary winding being connected to a triac dimmer for phase-controlling an AC input voltage;
a control circuit carrying out ON/OFF control of the switching element;
a secondary winding of the transformer supplying power to LEDs;
a bleeder that selectively passes a first current or a second current lower than the first current; and
a bleeder controller being connected to the bleeder and controls the bleeder and configured to pass the first current at least at the start of conduction of the triac dimmer.

2. The LED lighting apparatus of claim 1, wherein the bleeder controller controls the bleeder to pass the first current if load is light, and if load is heavy, the first current at the start of conduction of the triac dimmer.

3. The LED lighting apparatus of claim 1, wherein:
the transformer has an auxiliary winding; and
the bleeder controller is connected to the auxiliary winding, and controls the bleeder to pass one of the first and second currents according to the value of a voltage generated by the auxiliary winding.

4. The LED lighting apparatus of claim 3, wherein
the bleeder controller controls the bleeder to pass the first current if the value of the voltage generated by the auxiliary winding is lower than a predetermined value and the second current if the value of the voltage generated by the auxiliary winding is equal to or higher than the predetermined value.

5. The LED lighting apparatus of claim 1, further comprising:
an error amplifier that amplifies an error voltage between a voltage generated by a current passing through the LEDs and a reference voltage,
the bleeder controller controlling the bleeder to pass one of the first and second currents according to the amplified error voltage from the error amplifier.

6. The LED lighting apparatus of claim 5, wherein
the bleeder controller controls the bleeder to pass the first current if the amplified error voltage from the error amplifier is equal to or higher than a predetermined value and the second current if the amplified error voltage is lower than the predetermined value.

7. The LED lighting apparatus of claim 1, wherein
the bleeder controller controls the bleeder to pass one of the first and second currents according to the value of a voltage generated by the secondary winding of the transformer.

8. The LED lighting apparatus of claim 7, wherein
the bleeder controller controls the bleeder to pass the first current if the voltage of the secondary winding of the transformer is lower than a predetermined value and the second current if the voltage of the secondary winding is equal to or higher than the predetermined value.
